(19) United States
(12) Patent Application Publication
(10) Pub. No.: US 2002/0022455 A1
(43) Pub. Date: Feb. 21, 2002

(54) Method for reducing the power consumption of a wireless terminal, a communication system and a wireless terminal

(76) Inventors: Juha Salokannel, Kangasala (FI); Jari Jokela, Ylojarvi (FI)

Correspondence Address: PERMAN & GREEN, 425 POST ROAD, FAIRFIELD, CT, 06430, US

(21) Appl. No.: 09/932,881

(22) Filed: Aug. 20, 2001

(30) Foreign Application Priority Data
Aug. 21, 2000 (FI) 20001842

(51) Int. Cl. H04B 1/00

(52) U.S. Cl. 455/68; 455/574; 455/343

(57) ABSTRACT

The invention relates to a method for reducing the power consumption of a wireless terminal (MT1-MT4) communicating with an access point (AP1, AP2). In the method, the wireless terminal (MT1-MT4) is set to dormancy. An in-operation message (408) is transmitted at intervals from the wireless terminal (MT1-MT4) to the access point (AP1, AP2), wherein the wireless terminal is set in an active state for transmitting the in-operation message (408). In the method, the wireless terminal is returned to dormancy substantially immediately after the transmission of the in-operation message (408).

The present invention relates to a method for reducing the power consumption of a wireless terminal according to the preamble of the appended claim 1. The invention also relates to a communication system as well as a wireless terminal to be used in the communication system.

Communication systems intended for an office environment, so-called local area networks (LAN), are largely implemented as wired systems. Thus, the data transmission connection between terminals and a server is implemented either electrically by means of a cable, or optically by means of an optical fibre. Such a fixed system has e.g. the advantage that it is possible to achieve relatively high data transmission rates. A drawback in such a fixed communication system is the fact that it is difficult to make changes, and the terminals must usually be placed relatively close to the connection points intended for them, affecting the movability of the terminal. The implementation of such a wired local area network in an already existing building is not always successful, or cabling afterwards is expensive. On the other hand, communication cables already existing in particularly old buildings are not necessarily suitable for fast data transmission.

For implementing local area networks, there are various wireless communication systems under development. Several wired communication systems are based on the use of radio signals in communication. One such communication system under development, based on radio communication, is the so-called HIPERLAN (High PErformance Radio Local Area Network). Such a radio network is also called a broadband radio access network (BRAN).

In version 2 of the HIPERLAN communication, the aim is to achieve a data transmission rate in the order of 25 Mbit/s, the maximum connection distance being some tens of metres. Such a system is suitable for use in the same building e.g. as an internal local area network for one office. There is also a so-called HIPERACCESS communication system under development, in which the aim is to achieve the same data transmission rate as in said HIPERLAN/2 communication system, but the aim is to achieve a connection distance of some hundreds of metres, wherein the HIPERACCESS system is suitable for use as a regional local area network for example in schools and larger building complexes.

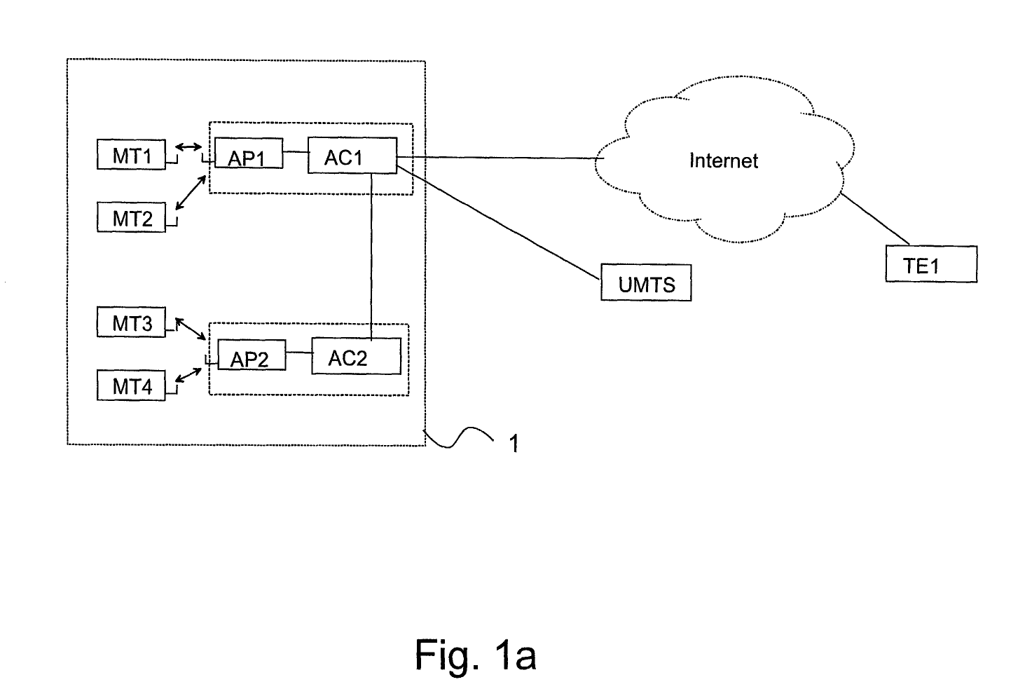

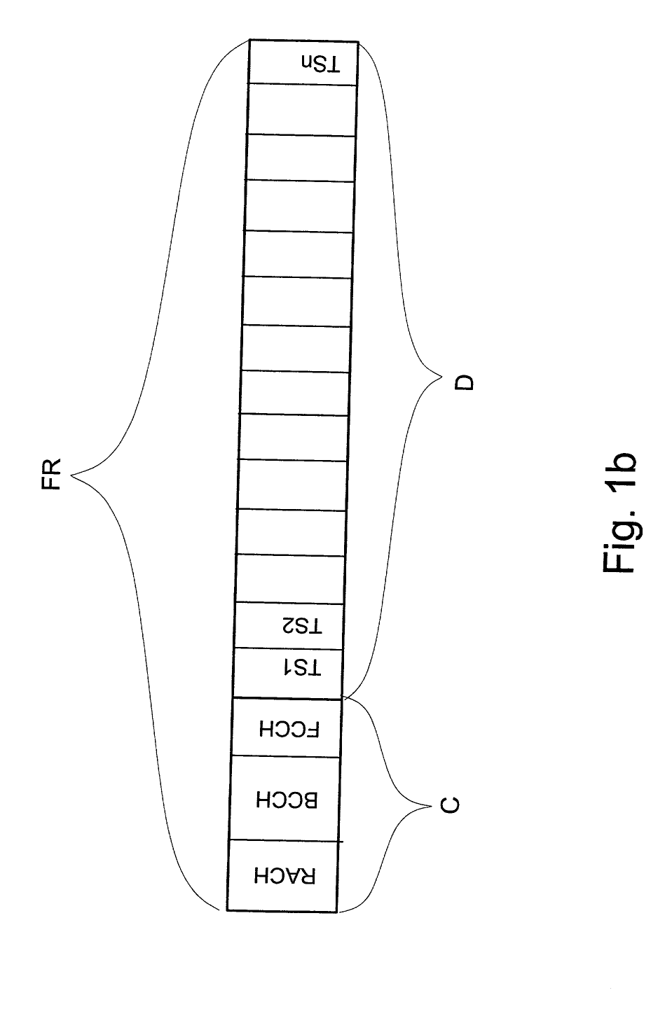

In the HIPERLAN/2 system which is used as an example, the frame structure used in the data link layer DLC is shown in a reduced manner in the appended FIG. 1b. The data frame consists of control fields RACH (Random Access CHannel), BCCH (Broadcast Control CHannel) and FCCH (Frequency Correction CHannel), as well as a given number of time slots, in which it is possible to transmit actual payload information.

Communication in the HIPERLAN/2 system is based on time division multiple access TDMA, wherein there can be several connections on the same channel simultaneously, but in said frame, each connection is allotted a time slot of its own, in which data is transmitted. Because the quantity of data to be transmitted is usually not constant in all the simultaneous connections, but it varies in time, a so-called adapted TDMA method is used, in which the number of time slots to be allocated for each data transmission connection may vary from zero to a maximum, depending on the loading situation at each time as well as on the data transmission capacity allocated for the connection.

For the time division multiple access to work, the terminals coupled to the same node must be synchronized with each other and with the transmission of the node. This can be achieved for example in such a way that the receiver of the mobile terminal receives signals on a channel. If no signal is detected on the channel, the receiver shifts to receive on another channel, until all the channels have been examined or a channel is found on which a signal is detected that is transmitted from an access point. By receiving and demodulating this signal, it is possible to find out the time of transmission of the control channel BCCH of the access point in question and to use this to synchronize the terminal. In some cases, the terminal may detect a signal from more than one access points, wherein the terminal preferably selects the access point with the greatest signal strength in the receiver and performs synchronization with this access point.

After the terminal has been synchronized with the access point, the terminal can start a connection set-up to couple to this access point. This can be performed preferably so that the terminal transmits a connection set-up request to the access point on the RACH control channel. In practice, this means that the terminal transmits in a time slot allocated for the RACH control channel and the access point simultaneously listens to communication on the channel, i.e. receives signals on the channel frequency used by the same. After detecting that a terminal is transmitting a connection set-up request message, the access point takes the measures required for setting up the connection, such as resource allocation for the connection, if possible. In the resource allocation, the quality of service requested for the connection is taken into account, affecting e.g. the number of time slots to be allocated for the connection. The access point informs the terminal whether the connection set-up is possible or not. If it has been possible to set up a connection, the access point transmits in the BCCH control field information e.g. on the transmission time slots, receiving time slots, connection identifier, etc. allocated for the connection. The number of transmission and receiving time slots is not necessarily the same, because in many cases the quantity of information to be transmitted is not the same in both directions. For example when using an Internet browser, considerably less information is transmitted from the terminal than is received in the terminal. Thus, for the terminal, fewer transmission time slots are needed than receiving time slots. Furthermore, the number of time slots allocated for the connection may preferably vary in different frames according to the need to transmit information at the time. The access point controller is provided with a so-called scheduler, which serves e.g. the purpose of allocating time slots for different connections as mentioned above. The scheduler is implemented preferably in an application program in the access point controller.

Because full-duplex communication is needed in local area networks, also a full-duplex data transmission connection is needed on the radio channel. In a time division system, this can be implemented either in such a way that some of the time slots in a frame are allocated for transmission from the mobile terminal to the access point (uplink) and some are allocated for transmission from the access point to the mobile terminal (downlink), or in such a way that a separate frequency band is allocated for each communication direction. In the HIPERLAN/2 system, the first mentioned method is used, wherein the access point and the wireless terminals coupled therewith do not transmit simultaneously.

When implementing packet data transmission, there is no need for the wireless terminal to transmit and receive all the time but primarily only when packets are transmitted between the wireless terminal and the access point.

In the HIPERLAN/2 system, the wireless terminal must inform the access point at regular intervals that the wireless terminal is still in operation and within the service area of the access point. This is arranged in such a way that the access point transmits a message for initializing control on the operation (RLX_MT_ALIVE_REQUEST) preferably at the stage when the wireless terminal is coupled to the access point. In this initialization message, the access point e.g. informs the wireless terminal how often the wireless terminal should transmit in operation messages to the access point as a sign that the wireless terminal is still in operation. The wireless terminal transmits an acknowledgement message (RLX_MT_ALIVE_REQUEST_ACK) to the access point and sets an in-operation control timer in its initial value. This control timer is used by the wireless terminal for timing the transmission of in-operation messages. Also at the access point, a control timer is started to monitor whether the wireless terminal is still in operation. If the access point receives the in-operation message transmitted by the wireless terminal within the predetermined time, the access point will set the control timer in its initial value and start a new period of monitoring the operation. On the other hand, if the access point does not receive an in-operation message within the predetermined time, the access point will assume that the wireless terminal is not in operation or it is located in such a position that data transmission between the wireless terminal and the access point is not successful. As a result, the access point can terminate the connection to the wireless terminal and release the resources allocated for the connection for other use.

For reducing the power consumption of the wireless terminal, it is possible e.g. in the HIPERLAN/2 system to set the wireless terminal from an active state to dormancy. In dormancy, the wireless terminal does not perform transmission or reception of packets, wherein e.g. the functions of the radio part of the wireless terminal can be turned off. For switching to dormancy, the wireless terminal transmits to the access point a message requesting for switching to dormancy. If the access point deduces that the wireless terminal can be set to dormancy, the access point transmits an acknowledgement message on switching to dormancy, which is received by the wireless terminal which is then switched to dormancy. After this, a switch from dormancy to the active state is performed at regular intervals to transmit an in-operation message to the access point. At this stage, the wireless terminal sets the operation control timer in its initial value, wherein this control timer can be used by the wireless terminal to transmit in-operation messages at regular intervals.

At the stage when the access point receives the in-operation message, the access point will set the operating control timer in its initial value and transmit an in-operation message acknowledgement message to the wireless terminal. The wireless terminal will wait until it has received the acknowledgement message transmitted by the access point. First after this, the wireless terminal returns to dormancy. The time between the in-operation message and its acknowledgement message can be relatively long, due to e.g. loading of the access point. Because the wireless terminal is in the active state when waiting for the acknowledgement message, the power consumption of the wireless terminal will considerably increase particularly when the waiting time is prolonged.

It is an aim of the present invention to provide a method for reducing the power consumption of a wireless terminal. Furthermore, it is an aim of the invention to provide a communication system and a wireless terminal applying the method. The method according to the present invention is characterized in what will be presented in the characterizing part of the appended claim 1. The wireless communication system according to the present invention is characterized in what will be presented in the characterizing part of the appended claim 7. The wireless wireless terminal according to the present invention is characterized in what will be presented in the characterizing part of the appended claim 10.

The invention is based on the idea that an in-operation message to be transmitted from a wireless terminal is a message for which the wireless terminal will not wait for an acknowledgement message. Thus, the return of the wireless terminal to dormancy can be considerably accelerated.

Considerable advantages are achieved by the present invention when compared with methods and wireless communication systems of prior art. Using the method of the invention, the power consumption of wireless terminals can be reduced, because the wireless terminal can return, after the transmission of an in-operation message, to dormancy faster than in communication systems of prior art. Using the method of the invention, it is also possible to reduce the loading of an access point to some extent, because the access point does not need to send an acknowledgement message for each in-operation message. Thus, resources are released at the access point for the transmission of actual payload information.

In the following, the invention will be described in more detail with reference to the appended drawings, in which

FIG. 1a shows a communication system according to a preferred embodiment of the invention in a reduced block chart,

FIG. 1b shows a data frame in the HIPERLAN/2 system,

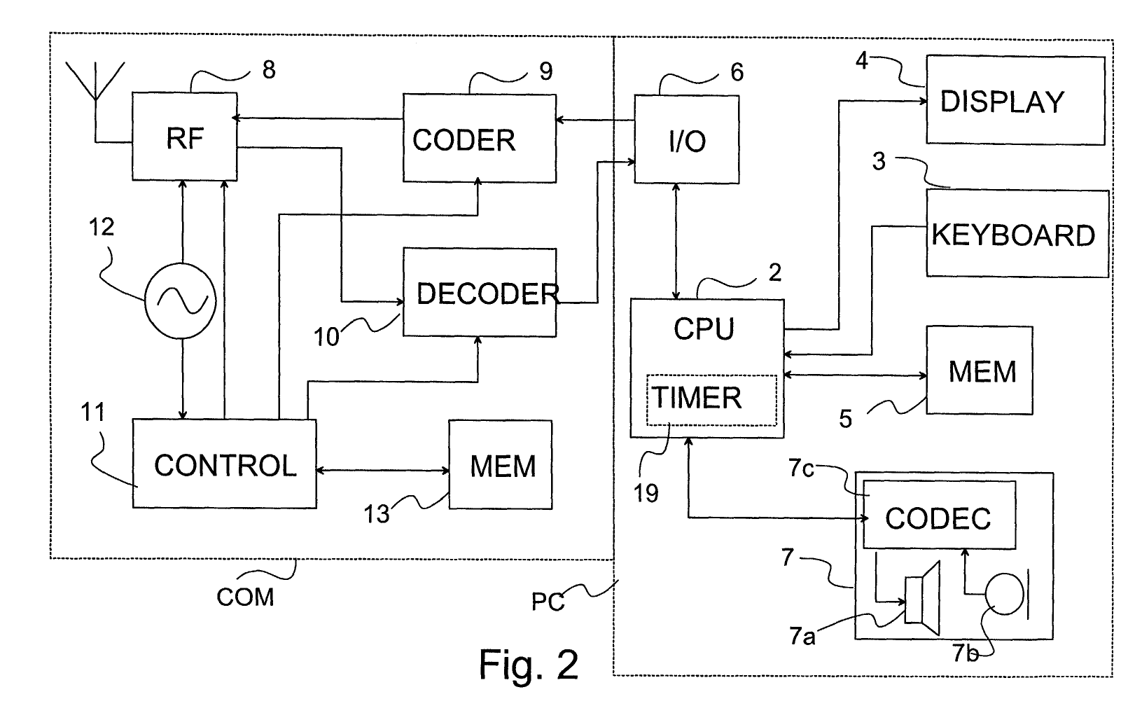

FIG. 2 shows a wireless terminal according to a preferred embodiment of the invention in a reduced block chart,

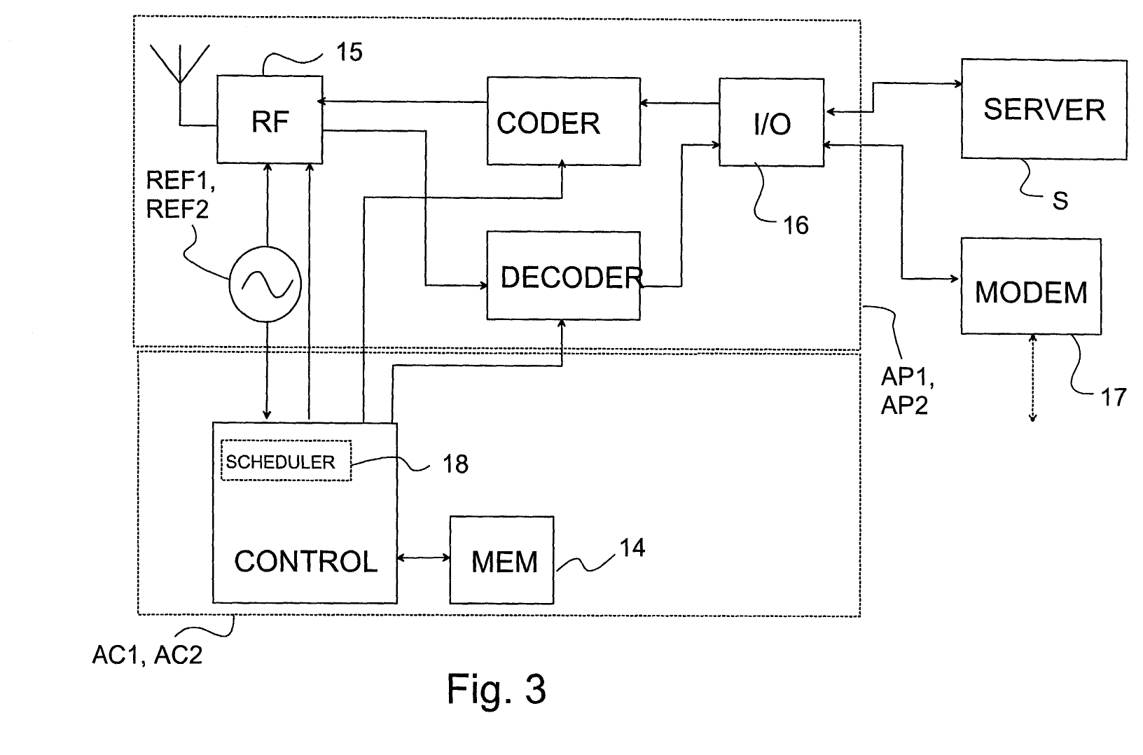

FIG. 3 shows an access point according to a preferred embodiment of the invention in a reduced block chart,

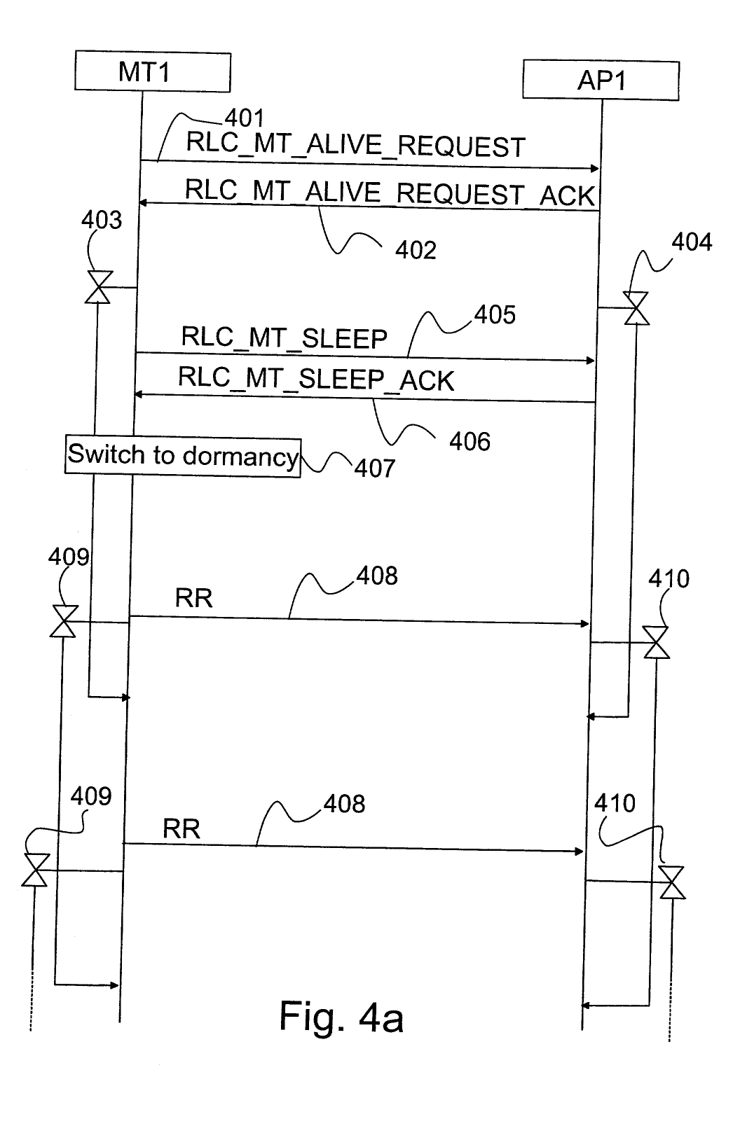

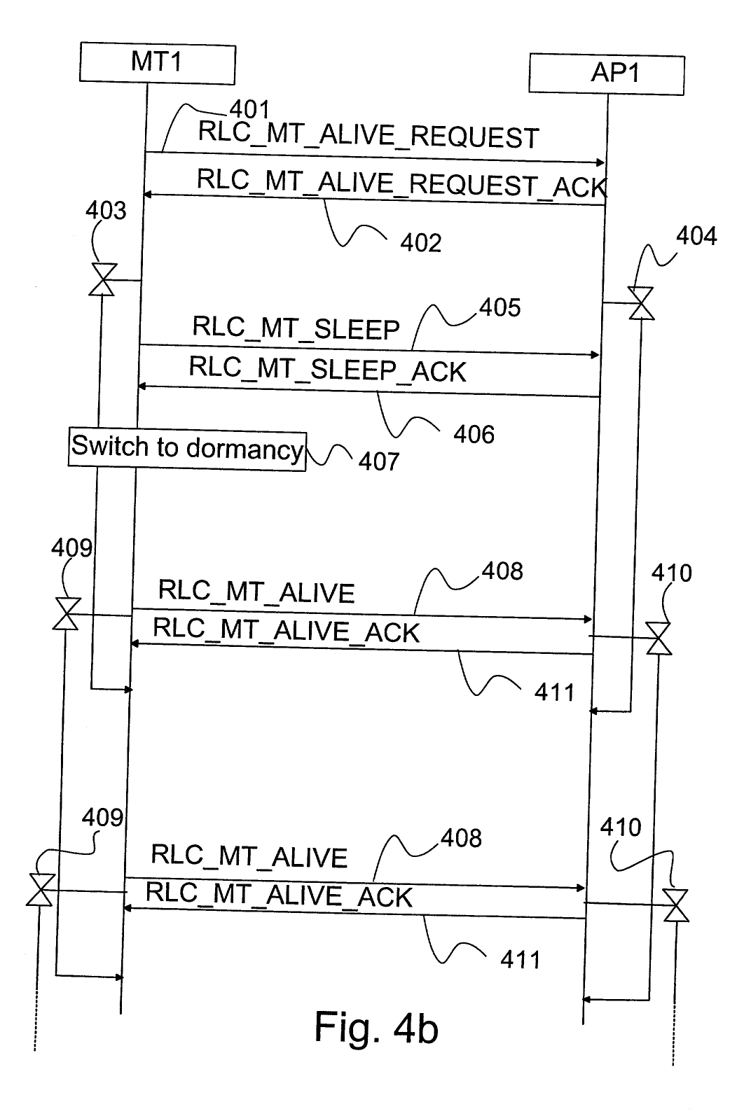

FIG. 4a shows the operation of the method according to a first preferred embodiment of the invention in a reduced flow chart, and

FIG. 4b shows the operation of the method according to the first preferred embodiment of the invention in a reduced flow chart.

In the following description of a communication system 1 according to a preferred embodiment of the invention, the HIPERLAN/2 system of FIG. 1a will be used as an example, but it is obvious that the invention is not limited solely to this system. The communication system 1 consists of mobile terminals MT1-MT4, one or several access points AP1, AP2, as well as access point controllers APC1, APC2. A radio connection is set up between the access point AP1, AP2 and the mobile station MT1-MT4, for transmitting e.g. signals required for setting up a connection and information during the connection, such as data packets of an Internet application. The access point controller APC1, APC2 controls the operation of the access point AP1, AP2 and the connections set up via them to mobile terminals MT1-MT4. In such a radio network, several access point controllers APC1, APC2 can communicate with each other as well as with other data networks, such as the Internet network, a UMTS mobile communication network (Universal Mobile Terminal System), etc., wherein the mobile terminal MT1-MT4 can communicate e.g. with a terminal TE1 coupled to the Internet data network.

FIG. 2 shows, in a reduced block chart, a mobile terminal MT1 complying with a preferred embodiment of the invention. The mobile terminal MT1 preferably comprises data processing functions PC and communication means COM to set up a data transmission connection to a mobile local area network. The mobile terminal can also be formed in such a way that a data processor, such as a portable computer, is connected e.g. with an expansion card comprising said communication means COM. The data processing functions PC preferably comprise a processor 2, such as a microprocessor, a microcontroller or the like, a keypad 3, a display means 4, memory means 5, and connection means 6. In addition, the data processing functions PC can comprise audio means 7, such as a speaker 7a, a microphone 7b, and a codec 7c, wherein the user can use the mobile terminal MT1 also e.g. for the transmission of speech. Information intended to be transmitted from the mobile terminal MT1 to the local area network is preferably transmitted by the connection means 6 to the communication means COM. In a corresponding manner, information received from the local area network 1 into the mobile terminal MT1 is transmitted to the data processing functions PC via said connection means 6.

The communication means COM comprise e.g. a radio part 8, an encoder 9, a decoder 10, a control means 11, as well as a reference oscillator 12. Furthermore, the communication means COM have a memory 13 for example for forming the transmission and receiving buffers required in the data transmission. The reference oscillator 12 is used to perform the necessary scheduling to synchronize the transmission and reception with the transmission and reception of the access point, as will be presented below in this description. The reference oscillator 12 can also be used for forming timing signals for the control means 11. It is obvious that the frequency formed by the reference oscillator 12 cannot be used as such in setting the channel frequency and in generating timing signals for the control means 11, wherein in practical applications, frequency conversion means (not shown) are used to convert the frequency of the reference oscillator 12 into frequencies needed in the radio part and a frequency suitable for controlling the operation of the control means 11.

The access point AP1 (FIG. 3) comprises, in a corresponding manner, first communication means 15 for setting up a data transmission connection to mobile terminals MT1-MT4. The local area network 1 according to the invention can also be implemented as a local area network with no connection to external data networks. Thus, one access point AP1 may be sufficient, with which the mobile terminals MT1-MT4 of the local area network communicate. In the wireless local area network, a data transmission connection 16 is preferably arranged from one or several access points AP1, AP2 to a data processor S which is generally called a server computer or, shorter, a server. Such a server comprises, in a way known per se, company data files, application software, etc. in a centralized manner. The users can thus start up applications installed on the server via the wireless terminal MT1.

The server or the access point AP1 may also comprise second communication means 17 to set up a data transmission connection to another data network, such as the Internet data network or a UMTS mobile communication network.

Each access point and mobile terminal is allocated an identification, wherein the access point is aware of the mobile stations coupled to the access point. In a corresponding manner, the wireless terminals separate the frames transmitted by different access points from each other. These identifications can also be used in a situation in which the connection of the wireless terminal is handed over from one access point to another access point, e.g. as a result of impaired quality of the connection.

In the following, the the method according to a first preferred embodiment of the invention will be described with reference to the flow chart shown in FIG. 4a. The interval of the iteration of operation messages 408 is advantageously selected at the access point AP1. Thus, the access point AP1 can deduce that the wireless terminal MT1 is in operation, if the access point AP1 receives in-operation messages 408 from the wireless terminal MT1 within this interval of iteration. The access point AP1 transmits a message on initializing monitoring of operation (RLC_MT_ALIVE_REQUEST) to the wireless terminal MT1. This is indicated by arrow 401 in FIG. 4a. The wireless terminal MT1 receives this message and finds out e.g. the interval of iteration determined by the access point for the transmission of in-operation messages. After this, the wireless terminal MT1 transmits an acknowledgement message (RLX_MT_ALIVE_REQUEST_ACK) to the access point (arrow 402) and sets an in-operation control timer in its initial value (403). After receiving the acknowledgement message, also the access point sets an in-operation control timer in its initial value (404). These control timers are preferably implemented by software or by timers or counters intended for time control, which is known as such. At the access point, the functions of said control timer can also be implemented e.g. in connection with the function of the scheduler 18.

The wireless terminal MT1 can be set to dormancy to reduce the power consumption in a situation in which the wireless terminal MT1 has no packets to be transmitted to the access point AP1 and also the access point AP1 has no packets to be transmitted to the wireless terminal MT1. The shift to dormancy is preferably performed as follows. If the wireless terminal MT1 has no packets to be transmitted, the wireless terminal MT1 sends a request to switch to dormancy (RLC_MT_SLEEP) to the access point AP1 (arrow 405). The access point AP1 will find out if it has packets to be transmitted to the wireless terminal MT1. If there are no packets to be transmitted, the access point sends the wireless terminal MT1 an acknowledgement to switch to dormancy (RLC_SLEEP_ACK) (arrow 406). In this acknowledgement message, the access point AP1 reports to the wireless terminal e.g. the time slots in which the wireless terminal MT1 should listen to signals transmitted by the access point. This is necessary so that the wireless terminal MT1 can shift to the active state, when necessary, e.g. when the access point AP1 has packets waiting to be transmitted to the wireless terminal MT1.

After the wireless terminal MT1 has received the acknowledgement to shift to dormancy, the wireless terminal MT1 shifts to dormancy (block 407). In dormancy, the wireless terminal MT1 has preferably primarily such functions in operation which are necessary for performing time control and maintaining data. The radio part COM is preferably turned off in dormancy. Also the processor 2 can be set in a power saving state.

At the stage when the timer 19 for monitoring the operation of the wireless terminal MT1 detects that an in-operation message should be transmitted, the wireless terminal MT1 shifts to the active state. In the active state, the functions of the radio part COM are turned on to make it possible to transmit messages. After this, the wireless terminal MT1 transmits an in-operation message 408 and sets the control timer 19 in its initial value (409). The in-operation message used in this preferred embodiment is a resource request (RR), in which the resource requirement is set as zero, that is, the wireless terminal MT1 does not actually request for resources (transmission time slots for transmitting packets). However, after receiving this message, the access point AP1 can deduce that the wireless terminal MT1 is still in operation and sets the monitoring time 18 of the access point in its initial value (410). In the method according to the present invention, the access point AP1 will not, however, generate an acknowledgement message to this in-operation message, wherein resources of the access point AP1 and of the communication system are also saved for other use. It is obvious that in connection with the invention, it is also possible to use another message than the above-mentioned resource request. It is primarily essential that the wireless terminal MT1 will not wait for a reply to the in-operation message 408 transmitted by it.

The above-mentioned timer function 19, 20 can be implemented e.g. on the principle of interruption, wherein the timer will produce an interrupt message to the processor 2. As a result, the processor will move on to an interrupt service program provided with operations defined for setting the wireless terminal MT1 in an active state. It is obvious that other methods can be used as well for shifting from dormancy to the active state.

If, for any reason, the access point AP1 does not receive or accept said in-operation message 408, it is possible to apply a method according to a second advantageous embodiment of the invention, shown in a reduced manner by the flow chart of FIG. 4b. In this embodiment, the in-operation message used is a message (RLC_MT_ALIVE) according to prior art, transmitted at regular intervals by the wireless terminal MT1. The access point AP1 receives this message, sets its control timer in its initial value (block 410), and transmits an acknowledgement message (RLC_MT_ALIVE_ACK, arrow 411). The wireless terminal MT1 will not, however, wait for the transmission of this acknowledgement message, but will, substantially immediately after the transmission of the in-operation message 408, shift to dormancy to wait for the transmission of the next in-operation message.

In addition to transmitting the above-mentioned in-operation messages 408, the wireless terminal MT1 will shift from dormancy to the active state for the duration of the time slot which the wireless terminal MT1 is determined to listen to receive signals transmitted by the access point. It is obvious that the present invention is not limited solely to the above-presented embodiments, but it can be modified within the scope of the appended claims.

1. Method for reducing the power consumption of a wireless terminal (MT1-MT4) communicating with an access point (AP1, AP2), in which method the wireless terminal (MT1-MT4) is set to dormancy, an in-operation message (408) is transmitted at intervals from the wireless terminal (MT1-MT4) to the access point (AP1, Ap2), and for sending the in-operation message (408), the wireless terminal is set in an active state, characterized in that in the method, the wireless terminal is returned to dormancy substantially immediately after the transmission of the in-operation message (408).

2. The method according to claim 1, characterized in that the in-operation message (408) used is a message to which no acknowledgement message is transmitted from the access point (AP1, AP2).

3. The method according to claim 1 or 2, characterized in that the in-operation message (408) used is a resource request (RR), in which the resource requirement is set as a value for which no resource allocation is performed for the wireless terminal (MT1-MT4).

4. The method according to claim 1, characterized in that the in-operation message (408) used is a message to which an acknowledgement message is transmitted from the access point (AP1, AP2), and that the wireless terminal (MT1-MT4) leaves said acknowledgement message unreceived.

5. The method according to any of the claims 1 to 4, characterized in that in connection with the setting to dormancy, a maximum transmission interval is selected for the in-operation messages (408), wherein the wireless terminal (MT1-MT4) shifts to the active state for transmitting the in-operation message (408) before the selected maximum interval has expired from the transmission of the previous in-operation message (408), and that the reception of in-operation messages (408) is monitored at the access point (AP1, AP2) within the maximum interval.

6. The method according to any of the claims 1 to 5, characterized in that the HIPERLAN/2 system is used in data transmission between the access point (AP1, AP2) and the wireless terminal.

7. A communication system comprising at least one access point (AP1, AP2), at least one wireless terminal (MT1-MT4) communicating with the access point, means (2) for setting the wireless terminal (MT1-MT4) to dormancy for reducing the power consumption, means for transmitting an in-operation message (408) at intervals from the wireless terminal (MT1-MT4) to the access point (AP1, AP2), the wireless terminal being set in an active state for transmitting the in-operation message (408), characterized in that the wireless terminal is arranged to be returned to dormancy substantially immediately after the transmission of the in-operation message (408).

8. The communication system according to claim 7, characterized in that it comprises means (AC1, AC2) for selecting a maximum transmission interval for the in-operation messages (408) in connection with the setting to dormancy, wherein the wireless terminal (MT1-MT4) comprises means (2, 19) for setting to the active state for transmitting the in-operation message (408) before the selected maximum interval has expired from the transmission of the previous in-operation message (408), and that the access point (AP1, AP2) comprises means (18) for monitoring the reception of in-operation messages (408) within the maximum interval.

9. The method according to claim 7 or 8, characterized in that it comprises a HIPERLAN/2 system.

10. A wireless terminal (MT1-MT4) arranged to communicate with at least one access point, means (2) for setting the wireless terminal (MT1-MT4) to dormancy for reducing the power consumption, means (COM) for transmitting an in-operation message (408) at intervals to the access point (AP1, AP2), and for sending the in-operation message (408), the wireless terminal is set in an active state, characterized in that the wireless terminal is arranged to be returned to dormancy substantially immediately after the transmission of the in-operation message (408).
